(19) United States
(12) Patent Application Publication
(10) Pub. No.: US 2026/0335773 A1
(43) Pub. Date: Oct. 29, 2026

(54) SYSTEM FOR GAME PLAY ENGAGEMENT

(71) Applicant: Sony Interactive Entertainment Inc., Tokyo (JP)

(72) Inventors: Michael J. Fuery, Hayward, CA (US); Andrew Farrell, Los Angeles, CA (US); Luis Alfonso Cortes Garcia, Montebello, CA (US); Like Zhang, Fremont, CA (US); Vineet Sriram, San Francisco, CA (US)

(21) Appl. No.: 19/187,217

(22) Filed: Apr. 23, 2025

(51) Int. Cl. A63F 13/798; A63F 13/795; G10L 15/16

(52) U.S. Cl. CPC A63F 13/798; A63F 13/795; G10L 15/16

(57) ABSTRACT

Methods, systems, and apparatus, including computer programs encoded on a computer storage medium, for identifying one or more candidate users in a game engagement segment. In one aspect, a method comprises receiving a request from a first user, wherein the request comprises a set of one or more criteria for identifying candidate users for associating with the first user, generating a set of initial rules, each initial rule for identifying an attribute corresponding with a respective criterion of the set of one or more criteria, and applying the set of initial rules to a database to identify one or more candidate users, selecting a subset of the one or more identified candidate users, and establishing an association between the first user and the selected subset of the one or more candidate users.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can identify one or more candidate users in a game engagement segment and create a game lobby for the one or more candidate users in response to a request from a first user. In particular, the system can identify one or more candidate users based on a set of criteria specified by the first user for the game engagement segment and can invite the candidate users to join the game lobby to facilitate playing a game.

In this specification, a game engagement segment is a set of candidate users that share one or more similar or desired compatible characteristics based on their playing tendencies and behaviors for a particular game. In particular, the first user can specify one or more characteristics that describe the first user's level of play or what the first user believes to be a compatible level of play for a game. As an example, the candidate users can have only played the game for a total of 10 hours, be expert players that can serve as teachers, users that have all beat the same challenge, or users that tend to log most of their playing hours for the game on a particular day of the week and at a particular time. Generally, similar or compatible user characteristics can indicate complementary styles of play, e.g., by allowing the first user to assemble a team of different strengths or positions for a group campaign, to receive advice from a more experienced player that has defeated a particular challenge the first user is struggling with, etc.

In this specification, a game lobby refers to a dedicated user interface where users in a game engagement segment can convene and interact. In particular, the game lobby facilitates communication prior to playing the game, e.g., by providing a dedicated space for users in the game engagement segment to chat to determine a time when the majority of users in the game engagement segment can play the game, plotting a strategy for game play before attempting a challenge, or discussing what they are most excited about in a new release. In this context, creating a game lobby refers to generating and providing a game lobby UI to the first user and candidate users identified in the game engagement segment.

According to a first aspect there is provided a method for receiving a request from a first user, wherein the request comprises a set of one or more criteria for identifying candidate users for associating with the first user, generating a set of initial rules, each initial rule for identifying an attribute corresponding with a respective criterion of the set of one or more criteria, and applying the set of initial rules to a database to identify one or more candidate users, selecting a subset of the one or more identified candidate users, and establishing an association between the first user and the selected subset of the one or more candidate users.

In some implementations, the request is a natural language request.

In some implementations, applying the set of initial rules to the database to identify the one or more candidate users comprises identifying one or more precomputed attributes already present in the database using the set of initial rules, and in response to determining at least one initial rule does not correspond with a precomputed attribute, generating one or more new attributes in accordance with identifying relationships between the one or more precomputed attributes relevant to the at least one initial rule that does not correspond with a precomputed attribute.

In some implementations, generating the set of initial rules comprises processing an input comprising the set of one or more criteria using a language processing neural network with an instruction to generate a respective rule for each criterion in the set of criteria.

In some implementations, the method further comprises validating the initial rules, wherein validating comprises determining whether the set of initial rules satisfy the set of criteria of the request using the one or more identified candidate users, and in response to determining that at least one initial rule does not satisfy the request, correcting the at least one initial rule that does not satisfy the request.

In some implementations, determining whether the set of initial rules satisfy the set of criteria of the request comprises, for each initial rule of the set of initial rules, generating an indication of whether the initial rule satisfies the request based on a first validation criterion by processing an input comprising the initial rule corresponding with a first criterion and the one or more identified candidate users using a language processing neural network with an instruction to determine whether the one or more identified candidate users satisfies the request.

In some implementations, correcting the at least one initial rule that does not satisfy the request comprises processing an input comprising the at least one initial rule, at least one criterion corresponding with the at least one initial rule, the one or more identified candidate users, and a first validation criterion using a language processing neural network with an instruction to correct the at least one initial rule based on the first validation criterion.

In some implementations, selecting a subset of the one or more candidate users comprises performing candidate ranking based at least on the set of one or more criteria.

In some implementations, establishing the association between the first user and the selected subset of the one or more candidate users comprises providing, by way of a user interface, at least one mode of transmitting data for communication between the first user and the selected subset of the one or more candidate users.

In some implementations, the method further comprises initializing game play between the first user and at least one of the one or more candidate users.

In another aspect, there is provided a system comprising one or more computers and one or more storage devices storing instructions that are operable, when executed by the one or more computers, to cause the one or more computers to perform the method of any one of the example implementation methods described.

In another aspect, there is provided a computer storage medium encoded with a computer program, the program comprising instructions that are operable, when executed by data processing apparatus, to cause the data processing apparatus to perform the method of any one of the example implementation methods described.

Particular embodiments of the subject matter described in this specification can be implemented so as to realize one or more of the following advantages.

The system of this specification can identify a game engagement segment and create a game lobby to connect users that satisfy a set of criteria for playing a game in response to a user request. That is, the system can provide invitations to identified candidate users of the game engagement segment and create a game lobby user interface for facilitating data transmission between users in the game engagement segment.

The system of this specification can identify a game engagement segment at low latencies and without storing additional data, thereby reducing the use of computational resources, e.g., memory and processing power, relative to a system that generates and maintains a separate database of user attributes. In particular, the system can generate initial rules for identifying candidate users using data maintained in a database based on a respective set of attributes that correspond to the set of criteria specified by the user request using a machine learning model. The system can then leverage precomputed attributes in the database to identify the candidate users and can generate new attributes to fulfill the user request in near real-time by defining and executing parameterized queries at runtime. Moreover, the system can use precomputed attributes or filtering to restrict the portion of the database being queried to reduce the use of computational memory required to generate new attributes in order to identify the candidate users.

Additionally, the system of this specification allows for the iterative validation and refinement of the initial rules based on the candidate users identified from the database using the initial rules. The system can verify that the initial rules align with the set of criteria specified by the user request using chain-of-thought prompting. More specifically, the system can instruct the machine learning model to validate whether the identified candidate users satisfy the set of criteria specified in the user request by iteratively prompting the machine learning model to assess the candidate users with respect to each attribute, thereby reducing the use of computational resources relative to training or finetuning an additional machine learning model for validation. In addition, the system can facilitate online improvement of the validation process using data indicating whether the validated users accepted an invitation to join the created game lobby for the game engagement segment.

Furthermore, the system can democratize segment management using a natural language input, thereby removing the need for a data analytics expert to identify a game engagement segment. Generally, segment management requires sophisticated technical capabilities, e.g., knowledge of a database querying language. In contrast, the system of this specification can simplify the process of finding players in a particular community by empowering a user to assemble game engagement segments based on a set of user-specified criteria. The system can enhance gameplay by facilitating, e.g., the identification of teams for group challenges, the giving of advice from expert users to new players, and the determination of who is free to play a particular game when the requesting user is able to play.

Thus, the system can encourage game play by promoting user interaction and socialization within the game engagement segment that is parameterized by a user-specified set of criteria. Moreover, the system can robustly identify segment attributes for virtually all multiplayer games, therefore improving player satisfaction and increasing player retention, and promoting a deeper sense of identity and loyalty among users. Relatedly, the increased user engagement can provide incentives for third-parties to contribute data to further enhance the generation of game engagement segments for their user base.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A depicts example user interfaces for identifying individual players in a game engagement segment and creating a game lobby. FIG. 1B depicts an example game lobby user interface.

FIG. 2 is a system diagram of an example game play engagement system.

FIG. 3 is a flow diagram of an example process for generating a game lobby for an identified game engagement segment in response to a request from a first user.

FIG. 4 shows an example of a computing device and associated accessories that can be employed to execute implementations of the present disclosure.

Like reference numbers and designations in the various drawings indicate like elements.

### DETAILED DESCRIPTION

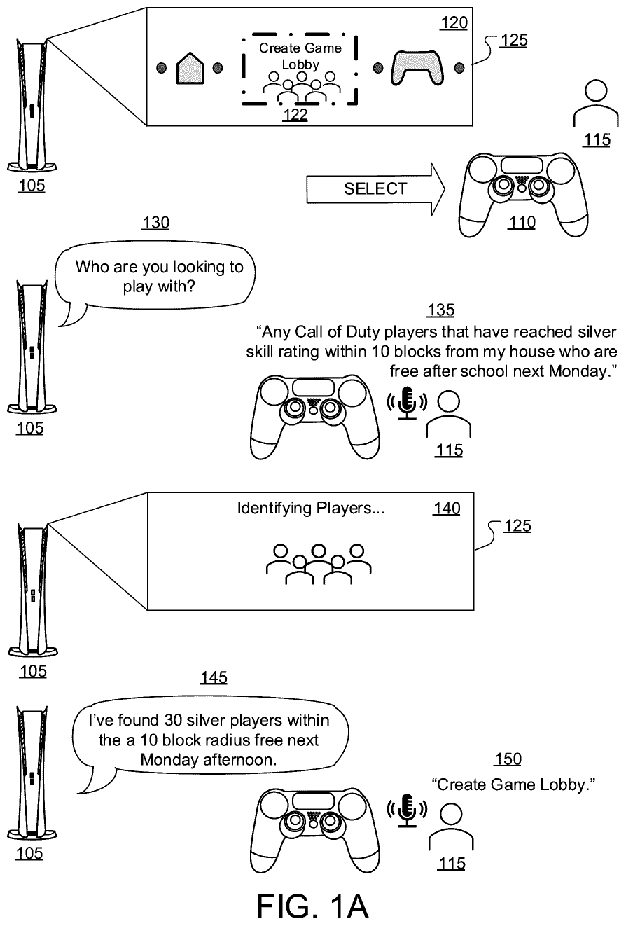

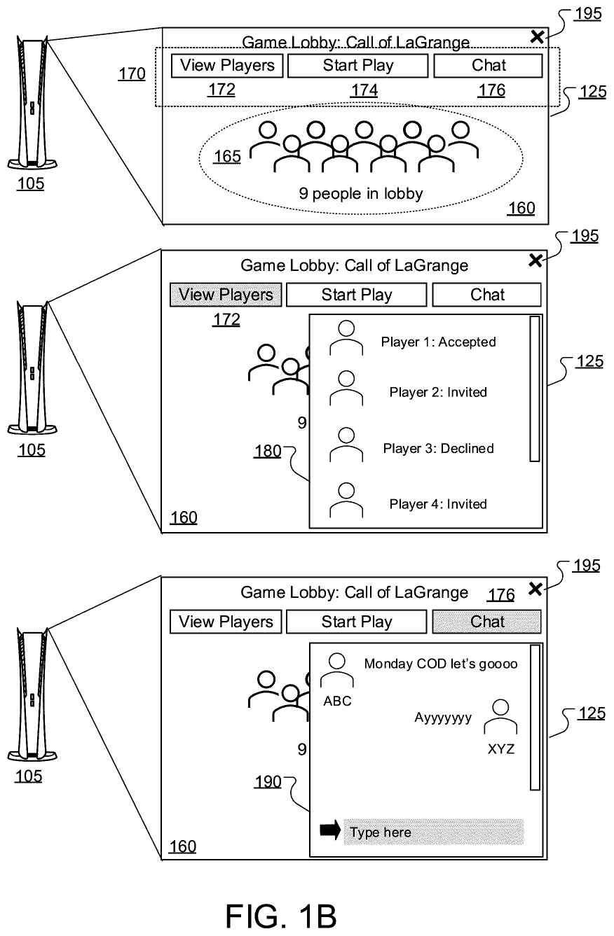

FIGS. 1A and 1B depict an example user flow, including user interfaces, for creating a game lobby for a game engagement segment. In the particular example depicted, the user flow includes user interfaces and audio instructions that are provided by a gaming console 105 to a user 115 operating a controller 110. For example, the gaming console 105 and controller 110 can be part of a game play engagement system that allows a user to specify a set of one or more criteria, e.g., characteristics that describe their level of play or what they believe to be a compatible level of play, to assemble a group of users that satisfy the set of one or more criteria for playing a game.

More specifically, the game play engagement system can allow users to create a game engagement segment, e.g., set of users that share one or more similar or desired compatible game play characteristics based on their playing tendencies and behaviors for a particular game. For example, a user can define a game engagement segment with users that have only played the game for less than a certain number of hours, expert users that can serve as teachers or advisors, users that have all reached the same level of play, or users that tend to log most of their playing hours for the game on a certain day of the week and time.

In particular, FIG. 1A depicts example user interfaces for identifying candidate users in a game engagement segment and creating a game lobby based on a request from the user 115. In this specification, a game lobby refers to a dedicated user interface where users in a game engagement segment can interact and convene to play a game, as is described in more detail with respect to FIG. 1B.

For example, the user 115 can navigate a set of options provided by the gaming console 105 and presented in a menu user interface (UI) 120. In this example, the gaming console is included in the game engagement system. In particular, the gaming console 105 can present the menu UI 120 on a display 125 of a computing device communicatively coupled with the gaming console 105 to allow the user 115 to interact with and select options from the menu UI 120. As an example, the options can include a home button, a game play button, a game lobby button 122, a profile button, a game store button, and a settings configuration button.

In this case, the user 115 has selected the game lobby option to “create a game lobby” 122. For example, the user 115 can select the game lobby option 122 by pressing a button or key on the controller 110. As another example, the user 115 can audibly select the game lobby option 122, e.g., by saying “I want to create a game lobby”.

By selecting the game lobby option 122, the user 115 can indicate to the system that the user desires to engage with other users for playing a particular game. For example, the user 115 can aim to interact with other users at the same skill level, e.g., users that have only played a particular game for a total of 10 hours, users with a certain success ratio at a particular level or users that have reached a recognition tier; expert players that can advise the user on a challenge; or players that tend to play the game at a certain time, on a certain day of the week, or both.

In response to the selection of the game lobby option 122, the system can use the game console 105 to prompt the user 115 to describe the set of criteria characterizing the candidate users that the user 115 aims to invite to the game lobby. In the particular example depicted, in response to the selection of the game lobby option 122 from the menu UI 120, the game console 105 can prompt 130 the user 115 by outputting audio waves through external acoustic transducers, e.g., one or more speakers associated with the display 125 to ask, e.g., “Who are you looking to play with?”. As another example, the game console 105 can be configured to provide an additional UI (not depicted) on the display 125, e.g., a chat UI, for the user 115 to receive the prompt as text and to enter text in an input portion describing the characteristics of the users for playing the game.

In this case, the user 115 responds to the prompt 130 by describing the characteristics of the desired game segment by speaking out loud, e.g., by audibly stating the response 135: “Any Call of Duty players that have reached silver skill rating within 10 blocks from my house who are free after school next Monday”. As an example, the controller 110 can include a built-in microphone that can detect the response 135. As another example, the computing device that includes the display 125 can include a built-in microphone that detects the response 135. In the case that the user is interacting with a chat UI to enter text describing the characteristics of the candidate users for playing the game, the game console 105 can directly receive the response by way of the UI.

More specifically, the response 135 can include details that characterize users in the game engagement segment. The set of criteria provided by the response are not required to be entered in a specific format by the user 115, e.g., the user 115 can specify the set of one or more criteria for candidate users that the system can identify and invite to the game lobby in any appropriate way. The system can be configured to transcribe audio, evaluate text, etc. in order to determine the relevant set of one or more criteria from the response 135.

Generally, the user 115 specifies similar or desired compatible characteristics in the response 135 as the set of one or more criteria, e.g., since similar or desired compatible characteristics can indicate complementary styles of play. For example, the set of one or more criteria can include skill level characteristics, e.g., based on a number of hours of total play, a game level attained, a play ranking, success metrics, trophies earned, or a game status achieved. As another example, the set of one or more criteria can include player personality characteristics in order to assemble a team of different strengths for group play, e.g., users who often chat with their teammates, users that fit a strategist personality, users that fit an explorer personality, or users that aim to complete games as quickly as possible. Alternatively, the user 115 can specify a position that they wish to play in a game as a response, e.g., “I want to play as a forward for a team in FIFA 25”, and the system can determine compatible players who enjoy playing other positions in the game in order to assemble the team for game play.

As yet another example, the set of one or more criteria can include set-up characteristics, e.g., users that have a network connection with a ping less than a specified number of milliseconds, users that play with access to a microphone, or users that play with a particular type of controller.

As a further example, the set of one or more criteria can include characteristics of users that the user 115 desires to interact with. For example, the set of one or more criteria can include location characteristics, e.g., in the neighborhood of the user 115, based on a zip code, or based on proximity to a landmark. As yet another example, the set of one or more criteria can include shared identity characteristics, e.g., alumni of a university, fans of a sports team, or people that speak a particular language.

In the particular example depicted, the user 115 aims to create a game lobby for (i) Call of Duty players that (ii) have reached a certain skill level, (iii) live relatively nearby, and (iv) are free at a particular time to engage in a special mission. In this case, based on the specified game, the location, player status, and game play behavior, the system can identify a set of users that satisfy the set of criteria specified by the response 135 as candidate users of the game engagement segment.

In this case, the response 135 explicitly identified the game that the user 115 desires to create the game lobby for. In some cases, the system can be configured to determine the game the user is referring to based on the most recently played game or a characteristic identified in the response, e.g., a success metric that is specific to a type of game. In another case, the system can determine that an additional prompt is necessary to clarify which game the user 115 desires to create the game lobby for. For example, the system can determine that the response “send invite to friends of friends, who live within neighborhood, have a kill to death ratio of 70%, and are alumni of my university” refers to a first-person shooter game or a multiplayer online battle arena game, and can additionally request that the user specify whether the game is Call of Duty, Halo, League of Legends, etc.

The system can process the response 135 to identify candidate users in the game engagement segment based on the characteristics specified in the response 135. In some cases, the game console 105 can provide a buffer UI 140 on the display 125 to indicate that the system is identifying candidate users for the game lobby.

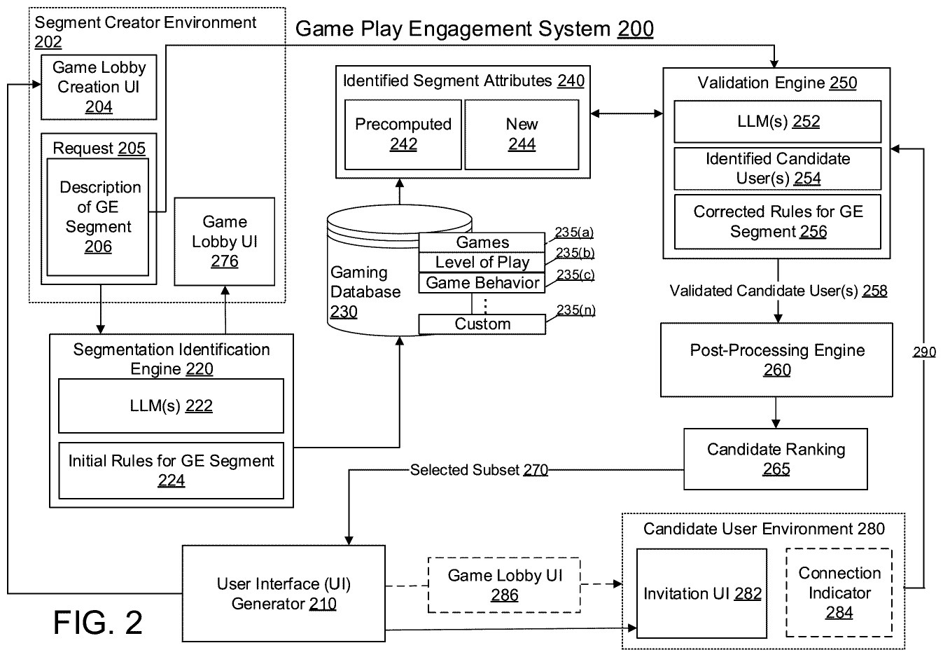

In particular, the system can process the response 135 to determine a set of one or more segmentation features that can be used to identify candidate users, e.g., from a gaming database. An example for how a game play engagement system can identify candidate users for a game engagement segment will be described in more detail with respect to FIG. 2.

In some cases, the system allows users of the system to opt-in for group game play by way of created game engagement segments. In this case, the system can identify candidate users additionally based on an opt-in indicator that indicates that the user has consented to be searchable for inclusion in game lobbies generated for game engagement segments.

Moreover, the system can be configured to ensure the user has specified sufficient criteria for identifying the game engagement segment that aligns with the aim of the game engagement segment they aim to create. In some cases, the system is configured to prompt the user 115 for additional details, e.g., in the case that the characteristics provided in the response 135 are not selective enough to narrow down the game engagement segment to a size that satisfies a maximum threshold criterion. For example, the system can identify that a number of users with the one or more specified characteristics exceeds a threshold number of users for inclusion in a game lobby, e.g., the system can limit the amount of candidate users for a game lobby to N users, e.g., 1000, 500, 30, etc. In this case, the system can prompt the user to specify additional criteria or to provide a range for one or more of the set of criteria, e.g., iteratively until the maximum threshold criterion for the game engagement segment is met. As an example, the maximum threshold criteria can be predetermined, e.g., by an administrator of the system or by the user 115.

Likewise, the system can be configured to ensure the user request is not too restrictive for identifying a game engagement segment, e.g., by determining whether the number of identified candidate users with the one or more specified characteristics in the user request does not satisfy a minimum threshold criterion. For example, the system can identify that the number of users is less than M users, e.g., 20, 10, 5 etc. In this case, the system can prompt the user 115 to determine which of the set of criteria can be relaxed to increase the number of identified candidate users by prompting the user to identify one or more of the least important criteria or to expand the range of allowable values for the criteria, e.g., iteratively until the minimum threshold criterion for the game engagement segment is met. As an example, the minimum threshold criteria can be predetermined, e.g., by an administrator of the system or by the user 115.

After the system has validated that the number of identified candidate users satisfies both the minimum and maximum threshold criteria for the game engagement segment, the system can alert the user to the number of candidate users identified in the game engagement segment. In the particular example depicted, the system has identified 30 candidate users for the game engagement segment that meet the criteria specified by the user 115, e.g., (i) Call of Duty players that (ii) have reached a certain skill level, (iii) live relatively nearby, and (iv) that are free at a particular time to engage in a special mission.

The game console 105 can indicate to the user 115 the number of candidate users by outputting audio waves through one or more speakers associated with the display 125 to inform the user 115. For example, the game console 105 can indicate to the user the number of players, e.g., “I've found 30 players.” As another example, the game console 105 can indicate to the user 115 the number of players that satisfy the request by restating the set of criteria in the request with the number of players, e.g., the audio output 145. The user 115 can then instruct the system to create the game lobby and invite the identified candidate users, e.g., by speaking an instruction 150 into a built-in microphone on the controller, on the display coupled with the game console 105, or another microphone associated with the system.

In some cases, the user 115 can elect to only invite a subset of the identified candidate users to the game lobby, e.g., by specifying “invite 15 of the players found”. In another case, the user 115 can update the criteria for the game engagement segment, e.g., by adding another characteristic, by removing a characteristic, or by specifying allowable values for a particular characteristic.

As another example, the game console 105 can be configured to provide an additional UI (not depicted) on the display 125, e.g., a chat UI, for the user 115 to receive the number of identified candidate users and to enter text in an input portion to instruct the system to create the game lobby, or to update the criteria for the game engagement segment.

FIG. 1B is a continuation of the user flow depicted in FIG. 1A. In particular, FIG. 1B depicts an example user interface for a created game lobby. For example, the user interface can have been created in response to the user 115 of FIG. 1A instructing the system to create the game room by speaking into a microphone on the controller.

The system can create the game lobby UI 160 and provide the game lobby UI to the user 115 and any candidate users that elect to join the game lobby, e.g., for display on a computing device communicatively coupled with the gaming console 105, e.g., the display 125 for the user 115. That is, the system can provide the game lobby UI 160 as a shared UI, e.g., shared among the candidate users in the game engagement segment that elected to join the game lobby and the first user, e.g., user 115, that created the game engagement segment.

More specifically, in response to receiving the instruction to create the game lobby, the system can create the game lobby UI 160 and provide the game lobby UI to the user 115. The system can then send invitations to each of the identified candidate users in the game engagement segment, or a subset of the identified candidate users in the game engagement segment. For example, the system can send the invitations by providing an unobtrusive pop-up on the respective displays coupled with the game consoles of each of the identified candidate users.

As an example, the invitation can include an option to join the game lobby and an option to decline the invitation, thereby allowing the candidate users to either accept or decline the invitation to join the game lobby. In the case that the candidate user accepts the invitation, the system can provide the game lobby UI 160 to the candidate user.

In the particular example depicted, the game lobby UI 160 can include the name of the game lobby UI, an option panel 170 to present allowable actions to the users in the game lobby, and a visualization of the users that have joined the game lobby 165. In this case, nine users are in the lobby, e.g., the user 115 that created the game engagement segment and eight candidate users that have accepted the invitation to join the game lobby. In some cases, after a specified duration of time, if the game lobby has not reached a particular number of members, the system can issue additional invitations to identified candidate users until the game room includes the particular number of members.

The game lobby UI 165 can be configured to allow users to enter and leave as they please, e.g., by selecting the close button 195 at any time the user is viewing the game lobby UI 165. As an example, after closing out of the game lobby, the user can rejoin the game lobby at any time, e.g., by selecting a rejoin game lobby button in the menu provided by their game console. In particular, the system can promote long term engagement by the game engagement segment by enabling users to join the game lobby whenever they feel inclined.

For example, the option panel 170 can be configured buttons that correspond with options for game engagement. In the particular example depicted, the option panel 170 includes a view players button 172, a start play button 174, and a chat button 176.

For example, in response to a selection of the view players button 172, the game lobby UI 160 can be configured to provide a floating window 180 that includes a list of all the users invited to join the game lobby with respective invite statuses, e.g., whether they have accepted, declined, or not yet viewed the invite yet. In some cases, after a predetermined time period, if the number of users that have accepted and joined the game lobby remains below a threshold number, e.g., a required number for game play, the system can issue additional invitations until the game lobby exceeds the threshold number. In this case, the system can re-prompt the user to modify one or more of the criteria specified in the description of the game engagement segment, as is described above.

As another example, in response to a selection of the chat button 176, the game lobby UI 160 can be configured to provide a floating window 190 that includes a chat widget for facilitating communication between the users, e.g., to greet each other, plan when the users will play, strategize for playing the game together, determine game configuration settings, etc. In some cases, the system is configured to moderate the content of the chat, e.g., to ensure that no spoilers are shared between users in the game engagement segment, that no violent or adult content is provided in the chat, etc.

As yet another example, in response to a selection of the start play button 174, any of the users present in the game lobby can commence game play. For example, the system can initialize a game environment for the users present in the game lobby, e.g., with the configured settings determined through interacting in the chat. In the case that some of the users have accepted the invitation and then exited the game lobby, only the users present in the game lobby will join game play. In particular, the chat functionality can be used to organize the date and time of playing the game, e.g., to maximize the number of users present in the game lobby at a desired time that can join game play.

FIG. 2 shows an example game play engagement system 200. The game play engagement system 200 is an example of a system implemented as computer programs on one or more computers in one or more locations in which the systems, components, and techniques described below are implemented. For example, the game play engagement system 200 can generate and provide the user interfaces of the user flow depicted in FIGS. 1A and 1B.

For example, the game engagement system 200 can receive a request 205 from a user including a description 206 of a game engagement (GE) segment from a segment creator environment 202. The system 200 can establish the segment creator environment 202 by generating a game lobby creation user interface (UI) 204, e.g., in response to a selection to generate a game lobby from an option menu, and providing the game lobby creation UI 204 to a user. As an example, the system 200 can generate the game lobby creation UI 204, e.g., using a UI generator 210 that is configured to generate a variety of user interfaces associated with the system 200, e.g., from user interface templates.

In particular, the system 200 can receive the description of the game engagement segment 206 that the user aims to create from the segment creator environment 202, e.g., by receiving an audio description of the segment or by receiving a textual input by way of the game lobby creation UI 204 as the request 205. For example, the request 205 can include a direction to “invite five players of Fortnite who are friends of friends and are as accurate as I am to within 3% in shooting with a kill to death ratio over 80% in Call of Duty”. As another example, the request 205 can include a direction to “invite anyone else that has just passed this challenge, and can beat the boss or in less than 7 min”. As a further example, the request 205 can include a request to assemble a sports team, e.g., “I need to find couple of quarterbacks for my team Reno Wreckers in Madden 24 who are at my level” or “I want to play as a forward for a team in Fifa 25.”

In the case that the description 206 of the game engagement segment includes a criteria that violates a set of moderation criteria, e.g., fair play criteria, protections on minors, etc., the system 200 can refuse to generate the game engagement segment or can modify the set of criteria to exclude the one or more criteria that violate the moderation criteria before identifying candidate users. In the case that the user repeatedly enters requests that violate the set of moderation criteria, the system 200 can block a user from generating game lobbies. In this case, the system 200 can remove the option to create a game lobby from a menu UI, e.g., on a homepage.

The system 200 can process the description of the segment 206 using a segmentation identification engine 220 to generate initial rules 224 that parametrize one or more criteria for identifying users in the game engagement segment. In particular, the segmentation identification engine 220 can identify the users based on the presence of one or more attributes, e.g., features that describe entities in a gaming database 230. For example, the gaming database 230 can include gameplay data, e.g., duration of play, recency of play, number of sessions, and play habits. As another example, the gaming database 230 can include user data, e.g., ownership of items, trophies won, and tournament rankings. While depicted here as a single database, in some cases, the system 200 can include multiple gaming databases.

More specifically, the segmentation engine 220 can generate rules that the system 200 can use to identify one or more candidates users that are associated with the attributes in the gaming database 230. Generally, each initial rule 224 can correspond with a particular attribute specified in the description of the segment. For example, the segmentation identification engine 220 can process the description of the segment 206 to generate one or more rules as part of a database language query, e.g., SQL queries, as the initial rules 224 for identifying the users in the game engagement segment from the database 230. In the example described in FIGS. 1A and 1B, the system 200 can use the segmentation identification engine 220 to generate a SQL query for an attribute corresponding for (i) Call of Duty players, an attribute for (ii) a certain skill level, an attribute for (iii) location near to the requesting user, and an attribute for (iv) availability at a particular time.

In some cases, the segmentation identification engine 220 can use the metadata of the gaming database 230 to identify existing attributes and determine how additional attributes relate to existing attributes. In particular, for requests that involve complex relationships between attributes, e.g., for identifying players who are as accurate as the requestor to within N % for a success metric in a first game and have solved a particular level without using a particular item in less than M minutes in another game, the segmentation identification engine 220 can determine whether any existing attributes can aid in the identification of the complex attributes.

The segmentation identification engine 220 can include one or more machine learning models that can process the description of the segment 206 to generate the initial rules for segment 224. In the particular example depicted, each machine learning model can have any appropriate machine learning architecture, e.g., a neural network, that can be configured to process a description of a segment 206 and generate initial rules 224. In particular, the one or more machine learning models can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, in the case that the description 206 is an audio description, the machine learning model(s) can be configured to process audio directly to generate the initial rules 224. In the case that the description 206 is an audio description and the machine learning model(s) are configured to process text, the engine 250 can transcribe the audio description into text using any appropriate speech recognition model before further processing the audio description using the machine learning model(s). As an example, the system 200 can use a streaming speech-to-text model to transcribe the audio description in near real-time, in order to reduce the latency of generating the game lobby for the game engagement segment.

In particular, the one or more machine learning models can be generative model(s). As an example, the machine learning model(s) can have a recurrent neural network architecture that is configured to sequentially process the description 206 and trained to perform next element prediction, e.g., to define a likelihood score distribution over a set of next elements. More specifically, the machine learning models can be a recurrent neural network (RNN), long short-term memory (LSTM), or gated-recurrent unit (GRU). As another example, the machine learning model(s) can be transformer-based, e.g., an encoder-decoder transformer, an encoder-only transformer, or a decoder-only transformer, configured to perform parallel processing of the contents of the multimodal input using a multi-headed attention mechanism.

In the particular example depicted, the segmentation identification engine 220 includes one or more language processing neural network, e.g., large language models LLM(s) 222 to process the description of the segment 206 to generate the one or more rules for identifying the users in the game engagement segment from the database 230. In particular, large language models have been demonstrated to achieve state of the art performance in semantic understanding, e.g., their ability to effectively capture semantic information from inputs.

More specifically, the system 200 can prompt the LLM(s) 222 to generate a query for identifying the game engagement segment based on the description of the segment 206. For example, the system can use in-context learning to provide a set of examples including requests and corresponding queries for identifying the candidate users. In some cases, the system 200 can additionally include the database metadata as context for the prompt, e.g., support data provided to aid the LLM(s) 222 in responding to the prompt. In particular, the metadata can be useful in determining relationships between existing attributes to identify candidate users that satisfy more complex relationships between attributes.

The system 200 can then apply the initial rules for the segment 224 to the gaming database 230 to identify the game engagement segment using one or more identified segment attributes 240, e.g., by querying the database 230. For example, the system 200 can establish a single database connection for executing the initial rules, e.g., using connection persistence to retain the connection instead of closing the connection with each query.

In some cases, the initial rules 224 correspond with precomputed attributes 242. In this case, the attributes corresponding with the initial rules 224 are already represented in the database, e.g., as a column or a primary key that can be used to identify a table of users associated with the attribute, and can be identified at low latency. In other cases, the initial rules 224 do not correspond with any precomputed attributes 242. In this case, the system 200 can generate new attributes 244 based on the initial rules 224, e.g., by determining relationships between the precomputed attributes 242 and data in the gaming database 230.

For example, the system 200 can generate new attributes 244 at low latencies by defining and executing parameterized queries at runtime. In particular, the system 200 can define a set of query templates with placeholder replacement variables that can be identified upon execution. As an example, a query template can define a select statement between two or more columns to identify an attribute. As another example, a query template can provide for indexing on search fields to enhance the execution of a query. By using a set of query templates, the system 200 can identify a relevant template and replacement variables based on the description 206 to use the reusable function.

In some cases, the system 200 can create dynamic tables to facilitate the creation of the new attributes 244. As an example, the system 200 can use the precomputed attributes 242 to identify a portion of relevant data before executing the parameterized queries, e.g., to filter the data in the database 230 before executing the parameterized query to reduce the use of computational memory and processing power. The system can then cache the dynamic tables to facilitate evaluations of the same or similar criteria in the future.

In some cases, the system 200 can first filter the data in the database 230 by identifying users that meet one or more predetermined relevance criteria. Then, the system 200 can evaluate the initial rules 224 on the filtered data. As an example, the predetermined relevance criteria can include evaluating players who are currently online, e.g., connected to the system 200. As another example, the predetermined relevance criteria can include identifying users within N degrees of social connections from the requesting user, e.g., within two degrees of social connection (“friends of friends”). As yet another example, the predetermined relevance criteria can include evaluating players who have recently played with the user.

In this case, the system 200 can dramatically reduce the data for querying based on the identified segment attributes 240. For example, in the case that the gaming database 230 includes one billion user accounts, the system can reduce computational time from hours to seconds by filtering using the predetermined relevance criteria.

In the particular example depicted, the gaming database 230 is a relational database that includes a games table 235(a), a level of play table 235(b), a game behavior table 235(c), and a custom table 235(n), e.g., for generated attributes. In this case, the system 200 can be configured to maintain new attributes 244 in a table, e.g., such that the new attributes 244 become precomputed attributes 242, e.g., for the generation of an additional game engagement segment using the attribute.

For the example described in FIGS. 1A and 1B, the system 200 can use the games table 235(a) to identify Call of Duty Players and the level of play table 235(b) to identify players at a certain skill level. As another example, the system 200 can create an attribute for location near to the requesting user and availability at a particular time based on data in, e.g., the game behavior 235(c) table and a system configuration table (not depicted). While described here with respect to a simplified relational database, the system 200 can use the segmentation identification engine 220 to identify and generate attributes from more complex databases, e.g., a graph database, a document database, a columnar database, or a multi-model database.

The system 200 can process the identified segment attributes 240 using a validation engine 250 to refine the identified segment attributes 240 based on the description of the segment 206. In particular, the system 200 can use the validation engine 250 to modify and correct the initial rules for the segment 224 based on the results, e.g., the identified candidate users 254 using the identified segment attributes 240. Thus, the system 200 can ensure that the request 205 to create a game lobby for the particular game engagement segment specified by the description 206 is met without spurious or unexpected results.

For example, the segmentation validation engine 250 can independently validate each identified segment attribute 240. In particular, the engine 250 can process the description 206, the identified users 254, and the initial rule for the attribute to analyze whether the identified users satisfy the description 206 provided by the requesting user. More specifically, the system 200 can analyze the identified users for each attribute to verify whether the identified users have the intended characteristic specified by the description 206 for the attribute.

As an example, for the request of FIGS. 1A and 1B: “Find Call of Duty players with a silver rating, who live within 10 blocks and are available Monday afternoon.”, the identified candidate user(s) 254 can include:
User A: Silver rating, local, but available only on Tuesday.
User B: Silver rating, local, available Monday.
User C: Gold rating, local, available Monday.

In this case, the system 200 can validate the identified candidate user(s) 254 by each of the identified attributes, e.g., silver attribute, distance within 10 blocks, and available on Monday. Since User A and User C do not match one of the three criteria, the system can apply a refined set of corrected rules 256 that place greater emphasis on the unmatched criteria, e.g., the “availability on Monday” and “silver rating” criteria, to ensure that the validated candidate user(s) 258 include only those users (like User B) who meet all the specified requirements. For example, this process can be implemented using chain-of-thought prompting, as described below, to ensure that only the best-matched candidates are selected.

Similar to the segmentation identification engine 220, the validation engine 250 can include one or more machine learning models with any appropriate machine learning model architecture. In the particular example depicted, the validation engine 250 includes one or more language processing neural networks, e.g., large language models (LLMs) 252. In some cases, the LLM(s) 252 can be the same LLM(s) 222 that are used to generate the initial rules 224. In this case, the segmentation validation engine 250 can validate each identified segment attribute 240 using a chain-of-thought prompting framework, e.g., using a sequence of prompts that decomposes the complex task of validation based on the set of criteria specified in the description 206 into a sequence of related sub-tasks that the LLM(s) 252 can consecutively perform to effectively complete the complex task of validation. In particular, the validation engine 250 can identify discrepancies and modify the initial rules to generate the corrected rules for the identified segment attributes 240.

For example, the validation engine 250 can process the identified candidate user(s) 254 using a prompt instructing the LLM(s) 252 to validate each attribute in the identified segment attributes 240 based on one or more validation criteria. More specifically, the validation engine 250 can validate each attribute in the attributes 240 using a respective chain-of-thought prompting sequence that decomposes the complex task of validation into simpler, related subtasks. Each subtask is sequentially performed by the LLM(s) 252 to ensure accuracy in validating the identified segment attributes.

In particular, the validation engine 250 can refine the initial rule generate for the attribute based on the description 206. As an example, in the case that the identified segment attributes 240 include a ping measure, e.g., a measure of the lag between a gaming device and a server, a matching gaming personality, a requirement that candidate users are “friends of friends”, and that the user has opted-in for group game play, the validation engine 250 can use the LLM(s) 252 to process separate prompts in respective chain-of-thought prompt sequences to validate the identified candidate user(s) 254 with respect to each of the (i) ping measure, (ii) the matching gaming personality, (iii) being “friends of friends”, and (iv) the opt-in indicator.

In particular, the validation engine 250 can validate that the identified candidate users 254 were identified in accordance with the description 206 by validating the identified candidate users 254 based on a set of aggregation validation criteria defined at a number of different aggregation levels, e.g., by performing a user-level validation, a game-level validation, and a concept-level validation for each of the attributes. In this case, a user-level validation refers to evaluating attributes specific to individual users, game-level validation refers to evaluating criteria relevant to gameplay or game-related metrics, and concept-level validation refers to ensuring candidates align conceptually with the user's intent rather than merely meeting explicit numeric or categorical database matches.

For example, each prompt in the chain-of-thought sequence can include the initial rule corresponding to the attribute, a description of the attribute, and the identified candidate user(s) 254 with an instruction to validate that the identified candidate user(s) satisfy the criterion provided by the description of the attribute with respect to an example of structured data for the given aggregation level, e.g., a respective hierarchical data file for each of the user-level, game-level, and concept-level validation. In this case, each next prompt in the sequence can correspond with an aggregation level not previously validated.

In the case that the validation engine 250 determines that the initial rule did not result in the intended identification of candidate user(s) for an attribute, the validation engine 250 can instruct the LLM(s) 252 to correct the initial rules 224 until the identified candidate user(s) reflect the criteria specified by the description 206. For example, the validation engine 250 can additionally prompt the LLM(s) 252 with the initial rule for the attribute that did not pass validation, the description of the attribute, and the specific validation that failed, e.g., an identification of the aggregation level the identified candidate user(s) 254 did not satisfy, with an instruction to correct the initial rule. Each time the rule is refined by the LLM(s) 252, the validation engine 250 can repeat the chain-of-thought validation at each of the specified aggregation-levels, e.g., until the corrected rule can be validated at each of the aggregation levels.

For example, for a request specifying: “I need to find Call of Duty players with a silver rating who live within 5 miles of downtown, are available on Saturday evenings, and have a kill/death ratio within 10% of my 1.5 kill/death ratio (K/D),” the system 200 can validate the identified candidate user(s) 254 based on the criteria of the request:
User 101: Silver rating, 4 miles from downtown, available Saturday evening, K/D of 1.6
User 102: Silver rating, 6 miles from downtown, available Saturday evening, K/D of 1.45
User 103: Silver rating, 3 miles from downtown, available Friday, K/D of 1.55
User 104: Gold rating, 4 miles from downtown, available Saturday evening, K/D of 1.5
User 105: Silver rating, 5 miles from downtown, available Saturday evening, K/D of 1.7
User 106: Silver rating, 2 miles from downtown, available Saturday evening, K/D of 1.5

In this case, the validation engine 250 can refine the identified candidate user(s) 254 based on user-level attributes, e.g., distance, availability, and game-level attributes, e.g., silver rating and kill/death ratio. As an example, the engine 250 can first evaluate the user-level attributes: (i) the engine 250 can evaluate the distance criterion and remove User 102 for exceeding the 5 mile limit, and (ii) the system 200 can evaluate the availability criterion and remove User 103 for not being available on Saturday. The engine 250 can then evaluate the game-level attributes: (iii) the engine 250 can evaluate the rating criterion and remove User 104, (iv) the engine 250 can evaluate the kill/death criterion and remove User 105 since the appropriate K/D range is 1.35-1.65.

After correcting the rules, the system 200 can use the corrected rules for the identified game engagement segment 256 to identify validated candidate user(s) 258. In some cases, the system 200 can re-query the gaming database 230 to identify the validated candidate user(s) 258. In other cases, the system 200 can filter the data identified using initial rules that have been validated by applying the corrected rules 256. For the example above, the system 200 can determine that User 101 and User 106 are the validated candidate user(s) 258 by filtering the data by applying the corrected rules 256.

As described with respect to FIG. 1A, in some cases, the system 200 can prompt the user to modify the set of criteria specified in the description 206 based on the identified candidate user(s) 258. For example, in the case that the number of identified candidate user(s) 258 does not satisfy a maximum threshold criterion, the system can prompt the user to narrow the search, e.g., by specifying additional criteria or a range of allowable values for one or more of the criteria. As another example, in the case that the number of identified candidate user(s) does not satisfy a minimum threshold criterion, the system 200 can prompt the user to expand the search, e.g., by relaxing one or more of the criteria.

The system 200 can then process the validated candidate user(s) 258 using a post-processing engine 260. For example, the post-processing engine 260 can rank the validated candidate user(s) 258 to determine a candidate ranking 265. As an example, the system 200 can rank the validated candidate user(s) 258 based on additional preferences, e.g., to prioritize users that have a tendency to join game lobbies. As another example, the system 200 can rank the validated candidate user(s) 258 based on the order of the validations, e.g., based on the user-level, game-level, and concept-level validations. In particular, the post-processing engine 260 can determine a match score for each user in order of increasingly specific validations, e.g., from concept-level to game-level to user-level. As an example, the system 200 can perform concept-level validation by ensuring that a user's request with respect to playing “Diablo IV Ultimate Edition” corresponds with the deluxe version of the game, instead of the standard Diablo IV.

In this case, the post-processing engine 260 can determine a match score that measures the similarity of the user's characteristics to each of the attributes identified from the description 206. As another example, the system 200 can rank the candidate user(s) 258 based on inferred or specified user-preferences, e.g., based on the description 206 or previous requests to generate a game lobby. As yet another example, the system 200 can rank the candidate user(s) 258 based on a player opt-in ratio that measures each candidate user's historical acceptance to rejection ratio for receiving invitations to join game lobbies.

For example, the system 200 can use the candidate ranking 265 to select a subset of the candidate user(s) 270. After identifying the selected subset 270, the system 200 can generate and provide a game lobby UI 276 to the requesting user and can generate and provide an invitation UI 272 to the selected subset of users 270, e.g., using the UI generator 210.

As an example, the system 200 can send invitations to the top N ranked candidate user(s) 258, e.g., the top 20, 50, 200, etc. As another example, the system 200 can sample users randomly from the top 10%, 25%, or 50% of the candidate ranking 265 to send the invitations. As yet another example, the system 200 can allow the user to specify one or more determinative factors that can be used to select the subset of users 270 from the candidate ranking 265.

By providing the invitation UI 272 to the candidate user, the system can establish a candidate user environment 280. As an example, the invitation UI 272 can be a non-obtrusive pop-up that includes a description of the game engagement segment and an option to send a connection indicator 284 that indicates whether the candidate user wishes to join the game lobby. For example, the connection indicator 284 can be sent in response to a selection of a join or decline radio button on the invitation UI 282. As another example, the connection indicator 284 can be a verbal assent or rejection of the invitation.

In some cases, the invitation UI 272 can include any appropriate additional information. For example, the invitation UI 272 can include the number of users currently in the game lobby and whether the user has previously played with any of the users in the game lobby. As another example, the invitation UI 272 can include summary statistics characterizing aggregated success metrics for the users currently in the game lobby, etc.

In response to a connection indicator 284 specifying that the candidate user wishes to join the game lobby, the system 200 can generate and provide the game lobby UI 286 to the candidate user. The candidate user can then join and view the game lobby UI 286, e.g., on a display associated with the candidate user's game console. An example game lobby UI 286 was described with respect to FIG. 1B. By joining the game lobby, the candidate user can interact with other users in the game lobby, e.g., including the requesting user and any other user that accepted the invite to join.

The system 200 can utilize real-time user interaction feedback 290 to enhance the system's accuracy and efficiency over time. In particular, the system 200 can allow for online improvement of the validated candidate users using the feedback 290. In some cases, the system 200 can provide the connection indicator 284 to the validation engine 250 as feedback 290 in order to refine the validation process, e.g., by refining the prompts in the sequence of chain-of-thought prompts. For example, the system 200 can modify the order of the validations performed, e.g., based on the aggregation level. As another example, the system 200 can modify the prompts used in the chain-of-thought prompting to refine the validation process.

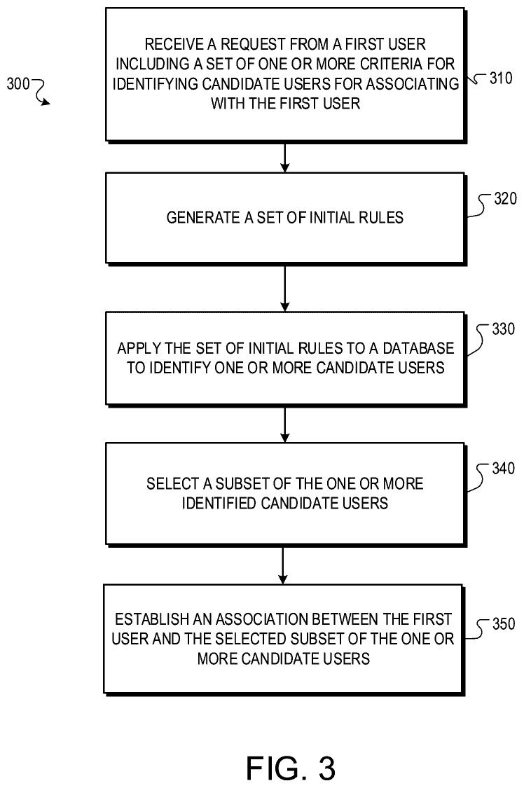

FIG. 3 is a flow diagram of an example process for generating a game lobby for a game engagement segment in response to a request from a first user. For convenience, the process 300 will be described as being performed by a system of one or more computers located in one or more locations. For example, a training system, e.g., the game play engagement system 200 of FIG. 2, appropriately programmed in accordance with this specification, can perform the process 300.

The system can receive a request from a first user including a set of one or more criteria for identifying candidate users for associating with the first user (step 310). As an example, the request can be a natural language request. In some cases, the request can be spoken into a microphone of the system. In other cases, the request can be a textual input to the system. In particular, the request can include an instruction to identify a game engagement segment, e.g., a set of candidate users that share one or more similar or desired compatible characteristics based on their playing tendencies and behaviors for a particular game.

The system can generate a set of initial rules (320). In particular, each initial rule can relate to identifying an attribute corresponding with a respective criterion of the set of one or more criteria. In some cases, the set of initial rules can be a set of queries for querying a database in accordance with attributes of the database. For example, the system can process an input including the set of one or more criteria using a language processing neural network with an instruction to generate a respective rule for each criterion in the set of criteria. As a further example, the input to the language processing neural network can additionally include metadata from the database, e.g., as context for determining the initial rules.

The system can apply the set of initial rules to a database to identify one or more candidate users (step 330). For example, the system can identify one or more precomputed attributes already present in the database using the set of initial rules. As another example, in response to determining that at least one initial rule does not correspond with a precomputed attribute, the system can generate one or more new attributes in accordance with identifying relationships between the one or more precomputed attributes relevant to the at least one initial rule that does not correspond with a precomputed attribute. The system can use the attributes to identify the one or more candidate users, e.g., as candidate users for the game engagement segment.

In some cases, the system can validate the initial rules using the one or more identified candidate users. In particular, can determine whether the set of initial rules satisfies the set of criteria of the request using the one or more identified candidate users. For example, the system can generate an indication of whether each initial rule satisfies the request based on a first validation criterion by processing an input that includes the initial rule corresponding with a first criterion and the one or more identified candidate users using a language processing neural network with an instruction to determine whether the one or more identified candidate users satisfies the request. As an example, the first validation criterion can be an aggregation validation criterion based on validating the request at a particular data aggregation level, e.g., by performing a user-level validation, a game-level validation, or a concept-level validation for the initial rule.

In the case that the system determines that at least one initial rule does not satisfy the request, the system can correct the at least one initial rule that does not satisfy the request. For example, the system can correct the at least one initial rule by processing an input including the at least one initial rule, at least one criterion corresponding with the at least one initial rule, the one or more identified candidate users, and a first validation criterion using a language processing neural network with an instruction to correct the at least one initial rule based on the first validation criterion. In this case, the first validation criterion is the validation criterion that the at least one initial rule did not satisfy.

The system can select a subset of the one or more identified candidate users (step 340). For example, the system can perform a candidate ranking of the one or more identified candidate users based at least on the set of one or more criteria. In some cases, the system can identify the N top candidates based on the ranking.

The system can establish an association between the first user and the selected subset of the one or more candidate users (step 350). For example, establishing an association between the first user and the selected subset of the one or more candidate users can involve providing, by way of a user interface (UI), at least one mode of transmitting data for communication between the first user and the selected subset of the one or more candidate users.

As an example, the user interface can be game lobby UI, e.g., a dedicated user interface where users in a game engagement segment can convene and interact. In particular, the system can provide a game lobby UI to allow for virtual congregation and can facilitate communication between the first user and the selected subset of candidate users that join the game lobby, e.g., through a chat UI accessible by way of the game lobby UI. In some cases, the system can initialize game play, e.g., of a video game, between the first user and at least one of the one or more candidate users, e.g., from the game lobby UI. In particular, the system can initialize game play in response to a selection by a user in the game lobby UI to start game play.

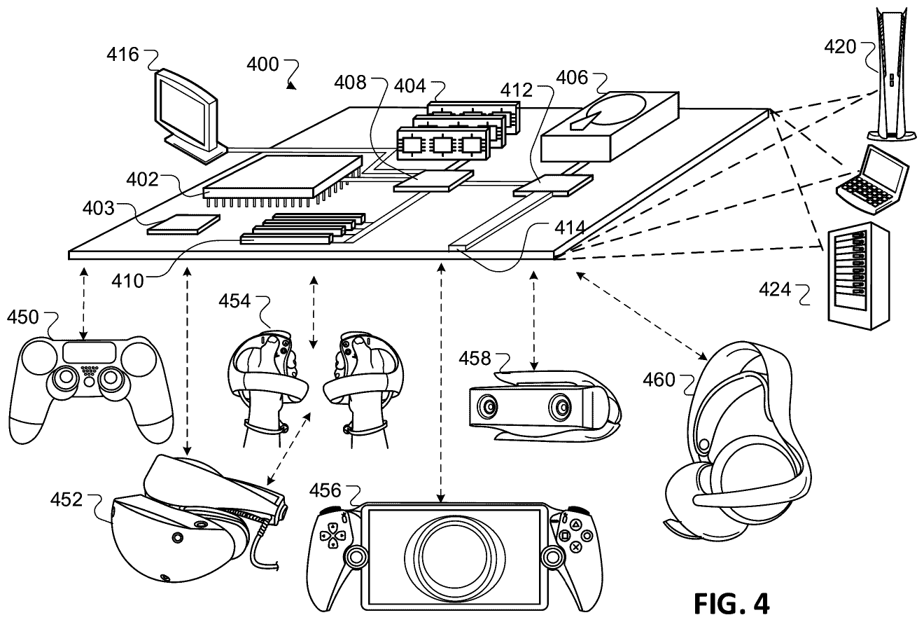

FIG. 4 shows an example of a computing device 400 and associated accessories that can be employed to execute implementations of the present disclosure. The computing device 400 can be a gaming console 420, such as PS5®, PS4®, PS3®, PS2® etc., or as one or more servers 424 or as a rack within a server. In some implementations, the computing device 400 may be implemented as a personal computer such as a laptop computer 422. In some implementations, the computing device 400 can be implemented as a mobile device such as the connected handheld gaming device 456. In some implementations, a computing device can include one or more of the computing device 400, and an entire system may be made up of multiple computing devices communicating with each other. For example, a gaming system can include one or more of a gaming console 420, one or more accessories, and a remote platform such as a cloud-based platform implemented on one or more servers 424. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 400 includes some combination of one or more processors or central processing units (CPUs) 402, one or more graphic processing units (GPUs) 403, memory 404, one or more storage devices 406, a high-speed interface 408, and/or a low-speed interface 412. In some implementations, the high-speed interface 408 connects to the memory 404 and multiple high-speed expansion ports 410. In certain implementations, the low-speed interface 412 connects to a low-speed expansion port 414 and the storage device 404. In some implementations, the high-speed interface 408 connects to the storage device 404. Each of the processor 402, the GPU 403, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 includes a volatile memory unit or units. Alternatively, or in addition, the memory 404 can include a non-volatile memory unit or units. The memory 404 may also include another form of a computer-readable medium, such as a magnetic or optical disk. In some implementations, the memory 404 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such High-speed memory can facilitate rapid data access and seamless multitasking, supporting gaming and multimedia applications.

The storage device 406 provides mass storage for the computing device 400. In some implementations, the storage device 406 may be or include a computer-readable medium, such as a hard disk device, an optical disk device, a flash memory, or other similar solid-state memory device, or an array of devices, including devices in a storage area network or other configurations. In some implementations, the storage device 406 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 406 can be configured to support expandable storage via compatible non-volatile memory express (NVMe) SSDs. Instructions can be stored in an information carrier, and when executed by one or more processing devices, such as processor 402, perform one or more methods, such as those described above. The instructions can also be stored by one or more storage devices, such as non-transitory computer-readable or machine-readable mediums, such as the memory 404, the storage device 406, or memory on the processor 402. The instructions can constitute software for providing interactive game play on a user interface such as a graphical user interface (GUI) presented on the display 416.

The high-speed interface 408 generally manages bandwidth-intensive operations for the computing device 400, while the low-speed interface 412 generally manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which accepts various expansion cards. In the implementation, the low-speed interface 412 is coupled to the storage device 406 and the low-speed expansion port 414. The low-speed expansion port 414, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 450 such as a DualSense®, DualShock®, or Access™ controllers for PlayStation® devices, a virtual reality (VR) or augmented reality (AR) headset 452 such as the PS VR2 headset, accessory controllers 454 such as PS VR2 Sense™, a handheld gaming device 456 such as PlayStation Portal®, a camera 458, and/or an earphone/headphone set 460 such as the PULSE Elite™ headset or the Pulse Explore™ earbuds. In some implementations, the computing device 400 includes one or more acoustic transducers, and/or is connected to one or more external acoustic transducers such as one or more speakers associated with the display 416.

The processor 402 can be implemented as a chipset of chips that include separate and multiple analog and digital processors. For example, the processor 402 can be a multi-core processor that supports high-speed processing and enables complex computational tasks, real-time physics simulations, and advanced artificial intelligence (AI) capabilities. In one example, the processor 402 includes at least 8 cores, at least 16 threads, and operates at variable frequencies around 3.5 GHz or more. In some implementations, the processor 402 may be a Complex Instruction Set Computers (CISC) processor, a Reduced Instruction Set Computer (RISC) processor, or a Minimal Instruction Set Computer (MISC) processor.

In some implementations, the GPU 403 includes a custom GPU that supports an advanced architecture such as the RDNA 2 architecture developed by AMD. In certain examples, the GPU 403 includes at least 36 compute units running at speeds of 2 GHz or more, and delivers performance of at least 10 teraflops. The GPU 403 can be configured to support high quality graphics rendering. For example, the GPU 403 can be configured to support hardware-accelerated ray tracing for enhanced realism in lighting and reflections, thereby providing a highly immersive gaming experience.

The computing device 400 can be configured to interact with one or more connected input/output or accessory device in providing the gaming experience. In some implementations, the computing device communicates with a handheld controller 450—e.g., a DualSense®, DualShock®, or Access™ controller for PlayStation® devices—to provide the gaming experience. The controller 450 can feature a high-fidelity haptic feedback system with one or more actuators that simulate a wide range of tactile sensations. In some implementations, the controller 450 includes one or more adaptive triggers that adjust resistance based on in-game actions to provide for a realistic feel.

The ergonomic design of the controller 450 can allow for comfortable use even in long gaming sessions. For example, the controller 450 can include textured grips and an optimized button layout. In some implementations, the controller 450 includes one or more of: integrated motion sensors, a high-resolution touchpad, and a built-in microphone array. The controller 450 includes an array of buttons, joysticks, and other controls that allow a user to interact with the computing device 400 to participate in interactive gameplay presented, for example, on a display device such as the display 416. The controller 450 can be powered by one or more regular or rechargeable batteries and supports both wireless and wired connectivity with the computing device 400, for example, via Bluetooth, WiFi, USB-C etc., or via a proprietary connection such as PlayStation Link™. In some implementations, the controller 450 includes a light bar and player indicators for visual feedback and customization.

In some implementations, the input/output or accessory device includes a VR/AR headset 452. One example of such a headset is the PlayStation VR2 (PS VR2) headset that is configured to provide an immersive and interactive gaming experience. In some implementations, the headset 452 features dual displays, e.g., organic light emitting device displays or micro-LED displays, with a combined resolution of 4000×2080 pixels or higher—thus providing sharp visuals and a wide field of view.

In some implementations, the VR/AR headset 452 includes eye-tracking technology that enables foveated rendering, by focusing on where the user is looking. In some implementations, the headset 452 includes integrated cameras that facilitate tracking head movements without external sensors. In some implementations, the headset includes haptic feedback for tactile sensations and/or one or more acoustic transducers configured to provide a spatial sound effect the user. The headset 452 can include an adjustable headband and cushioned padding, and can be configured to connect to the computing device 400 either over a wireless network (e.g., over a WiFi® or Bluetooth® connection, or a proprietary connection such as PlayStation Link™) or over a wire such as a USB-C cable.

In some implementations, the headset 452 can be configured to work in conjunction with one or more accessory controllers 454 such as the PlayStation VR2 Sense™ controllers. The accessory controllers 454 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 454 can provide a comfortable experience even during extended gameplay. In some implementations, the accessory controllers include one or more integrated sensors (accelerometer, gyroscope, etc.) and/or cameras to provide motion tracking. The accessory controllers 454 can be configured to connect to the computing device 400 and/or the headset 452 over a wireless connection such as WiFi® or Bluetooth®.

In some implementations, the computing device 400 is connected to a handheld gaming device 456 such as the PlayStation Portal®. The handheld gaming device 456 can be configured to stream games and media from the computing device 400 via a wireless connection such as WiFi® or Bluetooth®. The handheld gaming device 456 includes a high-resolution screen that allows users to play games and/or stream media remotely without using the display 416 connected to the computing device 400. This allows the display to be used for other purposes while the computing device 400 facilitates gameplay on the handheld gaming device 456. In some implementations, the handheld gaming device 456 is configured to act as a streaming receiver without running games natively on the device 456 itself. This makes the handheld gaming device 456 a convenient option for playing games run on the computing device 400, while leaving a TV connected to the computing device 400 free to be used for viewing other media. The handheld gaming device 456 can includes buttons and features similar to (or even same as) the controller 450, thus providing for a similar gaming experience as that with the controller 450.

In some implementations, the input/output or accessory devices includes a camera 458 and/or an earphone/headphone set 460 such as the PULSE Elite™ headset or the Pulse Explore™ earbuds. The camera 458 can be used to track user-movements, which in turn can be used as an input to an interactive game being executed on the computing device 400. The earphone/headphone set 460 can be used to provide audio feedback/output to a user from the computing device 400. In some implementations, the earphone/headphone set 460 can include a microphone to receive spoken inputs/instructions that in turn can be used to control an interactive game being executed on the computing device 400.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a request from a first user, wherein the request comprises a set of one or more criteria for identifying candidate users for associating with the first user;
generating a set of initial rules, each initial rule for identifying an attribute corresponding with a respective criterion of the set of one or more criteria; and
applying the set of initial rules to a database to identify one or more candidate users;
selecting a subset of the one or more identified candidate users; and
establishing an association between the first user and the selected subset of the one or more candidate users.

2. The computer-implemented method of claim 1, wherein the request is a natural language request.

3. The computer-implemented method of claim 1, wherein applying the set of initial rules to the database to identify the one or more candidate users comprises:
identifying one or more precomputed attributes already present in the database using the set of initial rules; and
in response to determining at least one initial rule does not correspond with a precomputed attribute, generating one or more new attributes in accordance with identifying relationships between the one or more precomputed attributes relevant to the at least one initial rule that does not correspond with a precomputed attribute.

4. The computer-implemented method of claim 1, wherein generating the set of initial rules comprises:
processing an input comprising the set of one or more criteria using a language processing neural network with an instruction to generate a respective rule for each criterion in the set of criteria.

5. The computer-implemented method of claim 1, further comprising validating the initial rules, wherein validating comprises:
determining whether the set of initial rules satisfy the set of criteria of the request using the one or more identified candidate users; and
in response to determining that at least one initial rule does not satisfy the request, correcting the at least one initial rule that does not satisfy the request.

6. The computer-implemented method of claim 5, wherein determining whether the set of initial rules satisfy the set of criteria of the request comprises, for each initial rule of the set of initial rules:
generating an indication of whether the initial rule satisfies the request based on a first validation criterion by processing an input comprising the initial rule corresponding with a first criterion and the one or more identified candidate users using a language processing neural network with an instruction to determine whether the one or more identified candidate users satisfies the request.

7. The computer-implemented method of claim 5, wherein correcting the at least one initial rule that does not satisfy the request comprises:
processing an input comprising the at least one initial rule, at least one criterion corresponding with the at least one initial rule, the one or more identified candidate users, and a first validation criterion using a language processing neural network with an instruction to correct the at least one initial rule based on the first validation criterion.

8. The computer-implemented method of claim 1, wherein selecting a subset of the one or more candidate users comprises performing candidate ranking based at least on the set of one or more criteria.

9. The computer-implemented method of claim 1, wherein establishing the association between the first user and the selected subset of the one or more candidate users comprises:
providing, by way of a user interface, at least one mode of transmitting data for communication between the first user and the selected subset of the one or more candidate users.

10. The computer-implemented method of claim 1, further comprising initializing game play between the first user and at least one of the one or more candidate users.

11. A system comprising one or more computers and one or more storage devices storing instructions that are operable, when executed by the one or more computers, to cause the one or more computers to perform operations comprising:
receiving a request from a first user, wherein the request comprises a set of one or more criteria for identifying candidate users for associating with the first user;
generating a set of initial rules, each initial rule for identifying an attribute corresponding with a respective criterion of the set of one or more criteria; and
applying the set of initial rules to a database to identify one or more candidate users;
selecting a subset of the one or more identified candidate users; and
establishing an association between the first user and the selected subset of the one or more candidate users.

12. The system of claim 11, wherein the request is a natural language request.

13. The system of claim 11, wherein applying the set of initial rules to the database to identify the one or more candidate users comprises:
identifying one or more precomputed attributes already present in the database using the set of initial rules; and
in response to determining at least one initial rule does not correspond with a precomputed attribute, generating one or more new attributes in accordance with identifying relationships between the one or more precomputed attributes relevant to the at least one initial rule that does not correspond with a precomputed attribute.

14. The system of claim 11, wherein generating the set of initial rules comprises:
processing an input comprising the set of one or more criteria using a language processing neural network with an instruction to generate a respective rule for each criterion in the set of criteria.

15. The system of claim 11, further comprising validating the initial rules, wherein validating comprises:
determining whether the set of initial rules satisfy the set of criteria of the request using the one or more identified candidate users; and
in response to determining that at least one initial rule does not satisfy the request, correcting the at least one initial rule that does not satisfy the request.

16. A computer storage medium encoded with a computer program, the program comprising instructions that are operable, when executed by data processing apparatus, to cause the data processing apparatus to perform operations comprising:
receiving a request from a first user, wherein the request comprises a set of one or more criteria for identifying candidate users for associating with the first user;
generating a set of initial rules, each initial rule for identifying an attribute corresponding with a respective criterion of the set of one or more criteria; and
applying the set of initial rules to a database to identify one or more candidate users;
selecting a subset of the one or more identified candidate users; and
establishing an association between the first user and the selected subset of the one or more candidate users.

17. The computer storage medium of claim 16, wherein the request is a natural language request.

18. The computer storage medium of claim 16, wherein applying the set of initial rules to the database to identify the one or more candidate users comprises:
identifying one or more precomputed attributes already present in the database using the set of initial rules; and
in response to determining at least one initial rule does not correspond with a precomputed attribute, generating one or more new attributes in accordance with identifying relationships between the one or more precomputed attributes relevant to the at least one initial rule that does not correspond with a precomputed attribute.

19. The computer storage medium of claim 16, wherein generating the set of initial rules comprises:
processing an input comprising the set of one or more criteria using a language processing neural network with an instruction to generate a respective rule for each criterion in the set of criteria.

20. The computer storage medium of claim 16, further comprising validating the initial rules, wherein validating comprises:
determining whether the set of initial rules satisfy the set of criteria of the request using the one or more identified candidate users; and
in response to determining that at least one initial rule does not satisfy the request, correcting the at least one initial rule that does not satisfy the request.
